(19) United States
(12) Patent Application Publication
(10) Pub. No.: US 2011/0074558 A1
(43) Pub. Date: Mar. 31, 2011

(54) Electronic Device, Alarm Control Method, and Recording Medium

(75) Inventor: Hiroaki Miura, Yokohama-shi (JP)

(73) Assignee: KYOCERA CORPORATION, Kyoto-shi, Kyoto (JP)

(21) Appl. No.: 12/934,622

(22) PCT Filed: Mar. 26, 2009
(86) PCT No.: PCT/JP2009/056202

§ 371 Date: Nov. 30, 2010

(30) Foreign Application Priority Data
Mar. 26, 2008 (JP) 2008-080049

(51) Int. Cl. G08B 1/00

(52) U.S. Cl. 340/309.16

(57) ABSTRACT

An electronic device 10 has an alarm 13; an alarm execution portion 170 making the alarm 13 execute an alarm operation at a previously set alarm time T(ALM); and a determination portion 170 determining whether or not an alarm stop condition for stopping in advance the alarm operation of the alarm execution portion 170 is satisfied in a first period PBAL from a predetermined time before the alarm time to the alarm time. The alarm execution portion 170 does not operate the alarm at the alarm time T(ALM) when the determination portion 170 determines that the alarm stop condition is satisfied.

### TECHNICAL FIELD

The present invention relates to an electronic device operating an alarm at an alarm time, an alarm control method, and a recording medium.

### BACKGROUND ART

Some mobile phones have alarm functions. In the case of using an alarm function of a mobile phone, a user usually selects an item of “clock” from a menu of the mobile phone and makes the mobile phone display an alarm setting screen. Then, in a state where the mobile phone displays the alarm setting screen, the user sets an alarm time on the mobile phone. Due to this, the alarm time is set on the mobile phone. When the time reaches the set alarm time, the mobile phone emits an alarm sound continuously for a predetermined period. In addition, to stop the alarm sound of the mobile phone in the middle, the user operates any of the keys of the mobile phone.

Patent Citations 1 to 3 disclose technologies to increase usability of alarm functions of mobile phones and other electronic devices.

Patent Citation 1: Japan Patent Publication No. 2004-166144 (A1)

Patent Citation 2: Japan Patent Publication No. 2007-124420 (A1)

Patent Citation 3: Japan Patent Publication No. 2007-166371 (A1)

### DISCLOSURE OF THE INVENTION

### Technical Problem

However, in the case of using an alarm function of a mobile phone or other electronic device, the following situation sometime occurs. For example, in the case where an alarm function is used as a wake-up function, the electronic device will emit an alarm sound when the time reaches the set alarm time even if the user of the electronic device has woken up before the set alarm time of the electronic device. In this situation, the user needs to perform an operation to stop the alarm of the electronic device after the alarm sound is emitted and therefore has the bother of dealing with the alarm of the electronic device.

Therefore, an electronic device, an alarm control method, and a recording medium improving the ease of canceling an alarm are desired.

### Technical Solution

An electronic device of a first aspect of the present invention has an alarm; an alarm execution portion making the alarm execute an alarm operation at a previously set alarm time; and a determination portion determining whether or not an alarm stop condition for stopping in advance the alarm operation by the alarm execution portion in a first period from a predetermined time before the alarm time to the alarm time is satisfied. The alarm execution portion does not operate the alarm at the alarm time in a case where the determination portion determines that the alarm stop condition is satisfied.

Preferably, the electronic device may further have an operation portion, and the alarm execution portion need not operate the alarm at the alarm time in a case where the determination portion determines that the alarm stop condition is satisfied and where the operation portion is operated.

Preferably, the electronic device may further have a program executing portion executing a program, and the determination portion may determine that the alarm stop condition is satisfied in a case where the program executing portion is executing the program.

Preferably, the electronic device may further have a light receiving portion, and the determination portion may determine that the alarm stop condition is satisfied in a case where the light receiving portion receives light over a predetermined value.

Preferably, the electronic device may further have an operation portion, and the determination portion may determine that the alarm stop condition is satisfied in a case where the number of times of operation of the operation portion is a predetermined number or more.

Preferably, the electronic device may further have a control portion, and the control portion may set a power source in an on state when an off state of the power source is detected in the first period.

Preferably, the electronic device may further have a detection portion detecting movement of the electronic device, and the determination portion may determine that the alarm stop condition is satisfied in a case where the detection portion detects movement of the electronic device.

Preferably, the detection portion of the electronic device may have an acceleration sensor, may detect movement of the electronic device based on a detected acceleration of the acceleration sensor, and may detect the predetermined movement of the electronic device in a case where the detected acceleration is a predetermined value or more.

Preferably, the electronic device may further have a positional information acquiring portion acquiring positional information of the electronic device and a positional information memory portion storing the positional information which is previously acquired by the positional information acquiring portion, and the determination portion may determine that the alarm stop condition is satisfied in a case where the positional information previously acquired and stored in the positional information memory portion and the positional information which is acquired by the positional information acquiring portion are different from each other.

Preferably, the positional information acquiring portion of the electronic device may receive signals from GPS satellites and acquire the positional information based on the received signals.

Preferably, the electronic device may further have an alarm event setting portion setting an alarm event designating the alarm time; an alarm event storing portion storing the alarm event; and an alarm event cancellation control portion deleting the alarm event from the alarm event storing portion in a case where the alarm stop condition is determined to be satisfied, and the alarm execution portion may make the alarm execute an alarm operation at a designated time based on the alarm event.

An alarm control method of a second aspect of the present invention is an alarm control method of an electronic device performing an alarm operation. Further, the alarm control method has a determination step for determining whether or not an alarm stop condition for stopping in advance the alarm operation at an alarm time is satisfied in a first period from a predetermined time before the alarm time to the alarm time and a step for preventing an alarm operation from being executed at the alarm time in a case where the alarm stop condition is determined to be satisfied in the determination step.

A recording medium of a third aspect of the present invention is a recording medium recording a program which can be read by a computer of an electronic device connected to an alarm for an alarm operation, the recording medium making the computer execute a determination step for determining whether or not an alarm stop condition for stopping in advance the alarm operation at an alarm time is satisfied in a first period from a predetermined time before the alarm time to the alarm time and a step for preventing the alarm operation from being executed at the alarm time in a case where the alarm stop condition is determined to be satisfied in the determination step.

### ADVANTAGEOUS EFFECTS

According to the present invention, it becomes possible to increase the ease of alarm cancellation.

### BRIEF DESCRIPTION OF THE DRAWINGS

FIG. 1(A) is an external view of a mobile phone 10 opened in an open state, while FIG. 1(B) is an external view of the mobile phone 10 folded up in a closed state.

FIG. 2 is a block diagram of main electric circuits of the mobile phone in FIG. 1.

FIG. 3 is a block diagram of functions realized by a CPU in FIG. 2.

FIG. 4 is a view showing a relationship between a setting time of an alarm event and a period before the sound operation.

FIG. 5 is a flow chart of user alarm setting processing.

FIG. 6 is a flow chart of alarm event setting processing.

FIG. 7 is a flow chart of alarm event executing processing.

FIG. 8 is a flow chart of automatic canceling processing in a first example.

FIG. 9 is a flow chart of automatic canceling processing in a second example.

FIG. 10 is a flow chart of automatic canceling process in a third example.

FIG. 11 is a flow chart of automatic canceling processing in a fourth example.

FIG. 12 is a flow chart of a modified example of automatic canceling processing which is modified from the automatic canceling processing in the first example.

FIG. 13 is a block diagram showing main electric circuits of a mobile phone according to a second embodiment of the present invention.

FIG. 14 is a view explaining recorded data stored in the memory portion in FIG. 13.

FIG. 15 is a view showing the data structure of alarm event data in FIG. 14.

FIG. 16 is a flow chart of alarm event executing processing and alarm automatic canceling processing of the mobile phone in FIG. 13.

FIG. 17 is a block diagram showing main electric circuits of a mobile phone according to a third embodiment of the present invention.

FIG. 18 is a flow chart of processing for periodically acquiring positional information.

FIG. 19 is a flow chart of alarm event executing processing and alarm automatic canceling processing of the mobile phone in FIG. 17.

FIG. 20 is a flow chart of a modified example of processing for acquiring positional information modified from the processing for acquiring positional information in FIG. 18.

### EXPLANATION OF REFERENCES

10 . . . mobile phone, 11 . . . communication portion, 12 . . . operation portion, 13 . . . voice input/output portion, 14 . . . display portion, 15 . . . imaging portion, 16 . . . memory portion, 17 . . . CPU (control portion), 170 . . . main control portion, 171 . . . AP executing control portion, 172 . . . UI providing portion, 51 . . . acceleration sensor, 61 . . . GPS receiver

### BEST MODE FOR CARRYING OUT THE INVENTION

Below, embodiments of the present invention will be explained. In the following explanations, a mobile phone 10 will be explained as an example of an electronic device.

### First Embodiment

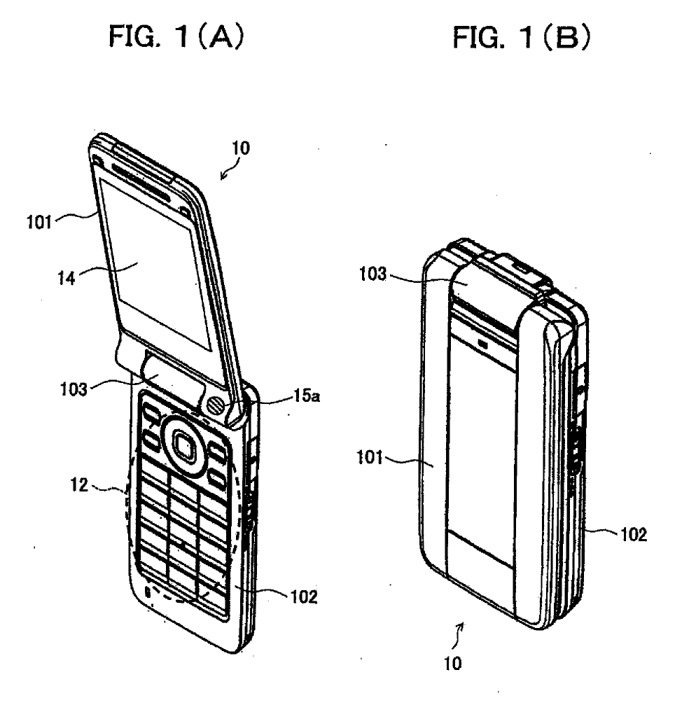

FIG. 1(A) is an external view of a mobile phone 10 of a first embodiment of the present invention. The mobile phone 10 has an alarm function to emit an alarm sound at a user setting time. As shown in FIG. 1, the mobile phone 10 has an upper housing 101, a lower housing 102, and a hinge portion 103. The hinge portion 103 connects the upper housing 101 and the lower housing 102 to be able to be opened and, closed. Therefore, the mobile phone 10 is able to be opened to an open state shown in FIG. 1(A) and to be closed to a closed state shown in FIG. 1(B). FIG. 1(A) shows the open state in which the mobile phone 10 is opened. FIG. 1(B) shows the closed state in which the mobile phone 10 is folded up. As shown in FIG. 1(A), a display portion 14 is arranged in the inside surface of the upper housing 101. The surface is not exposed as an outer part of the mobile phone 10 in the closed state shown in FIG. 1(B). In addition, as shown in FIG. 1(A), an operation portion 12 is arranged in the inside surface of the lower housing 102 and the surface is not exposed as an outer part of the mobile phone 10 in the closed state shown in FIG. 1(B).

Note that the open state and the closed state of the mobile phone 10 are monitored by a CPU 17 described below. The CPU 17 is able to detect the closed state of the mobile phone 10. Particularly, the CPU 17 monitors whether or not a not-shown detection switch arranged in the lower housing 102 is being pressed by a not-shown projection provided in the upper housing 101, for example. Then, in a case where the mobile phone 10 is closed to press the detection switch downward, the CPU 17 determines the closed state. When the mobile phone 10 is opened and the detection switch is not pressed downwardly, the CPU 17 determines the open state. The open state and the closed state of the mobile phone 10 may be detected by any type of sensor other than a detection switch.

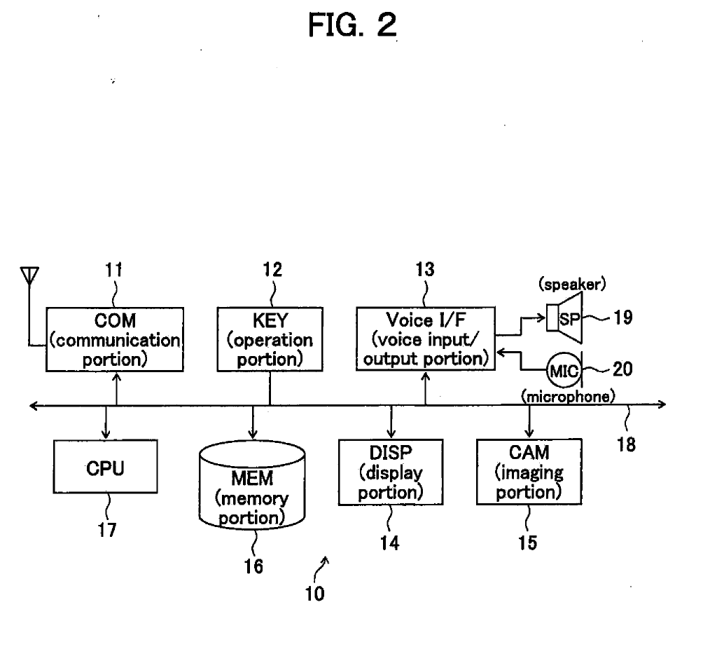

FIG. 2 shows a block diagram of main electric circuits of the mobile phone 10 of the first embodiment of the present invention. As shown in FIG. 2, the mobile phone 10 has a communication portion (COM) 11, an operation portion (KEY) 12, a voice input/output portion (Voice I/F) 13, a display portion (DISP) 14, an imaging portion (CAM) 15, a memory portion (MEM) 16, a CPU (central processing unit) 17, and a system bus 18 connected thereto. The system bus 18 has a plurality of signal lines used as an address bus, a data bus, and a control bus. The CPU 17 manages and controls operations of the electric circuits of the mobile phone 10.

The communication portion 11 communicates wirelessly with not-shown base stations of a wireless communication system. The communication portion 11 sends and receives communication data with another not-shown mobile phone or a server device of the wireless communication system. The communication data of the mobile phone 10 includes, for example, voice sound data for voice conversions, e-mail data for sending or receiving of e-mail, web page data for web browsing, and so on.

The operation portion 12 has a plurality of key switches. The key switches are assigned different types of functions. The key switches function as a power key, a speech key, number keys, character keys, up-, down-, left-, and right-direction keys, and so on. To set an alarm emitting time for using an alarm function of the mobile phone 10, a user operates the keys of the operation portion 12. To set an alarm stop condition for cancellation of an alarm in advance, a user operates the keys of the operation portion 12. When a user operates the keys of the operation portion 12, the operation portion 12 generates signals corresponding to the operated keys and outputs them to the CPU 17.

The voice input/output portion 13 is connected to a speaker 19 and to a microphone 20. The voice input/output portion 13 performs an input/output processing of voice signals output from the speaker 19 and input from the microphone 20. When an analog voice signal is input from the microphone 20, the voice input/output portion 13 amplifies the input analog voice, converts the amplified analog signal to digital data, and executes signal encoding processing of the digital data and so on. In addition, the voice input/output portion 13 outputs the generated signal including digital sound data to the CPU 17. When a signal including digital sound data is input from the CPU 17, the voice input/output portion 13 decodes the input sound data, converts the decoded sound data to an analog signal, and amplifies the voice analog signal. In addition, the voice input/output portion 13 outputs the amplified voice analog signal to the speaker 19. The speaker 19 outputs the voice. Then, the CPU 17 generates sound data of an alarm sound, for example. In this case, the voice input/output portion 13 generates an analog alarm signal and the speaker 19 outputs the alarm sound. As described above, the voice input/output portion 13 and the speaker 19 function as an information portion to inform an alarm when the time reaches an alarm setting time.

The display portion 14 has a LCD (liquid crystal display device) or an organic EL (electro-luminescence) device, for example. The LCD or the organic EL device has a plurality of pixels. The pixels are arranged in a matrix layout. Each pixel has elements for emitting light in a plurality of colors. When the CPU 17 generates display data and when this display data is written in a predetermined area (VRAM area) of the memory portion 16, the display portion 14 reads out the display data from the VRAM area and displays an image corresponding to the display data. Using this, the display portion 14 displays a phone number of a receiver of a wireless call of the communication portion 11, a phone number of a sender of a received call, a received or sent content of an e-mail, a web page, a date, a clock time, a remaining battery power, success or failure of a call, text, a standby screen, and so on. In addition, the display portion 14 displays an alarm setting screen, a selection screen of an alarm stop condition, an alarm screen, and so on.

The imaging portion 15 has a CCD (charge coupled device), CMOS (complementary metal oxide semiconductor) imaging sensor, or other photoelectric conversion element and a control circuit thereof. The imaging portion 15 functions as a camera. In addition, the imaging portion 15, as shown in FIG. 1(A), has a light receiving element 15a. The light receiving element 15a may be a photo sensor, for example. Further, the imaging portion 15 measures luminance of ambient light by the light receiving element 15a and determines an exposure for imaging. The imaging portion 15 outputs the detected data 52 to the CPU 17 and the detected data 52 is detected by the light receiving element 15a to show circumstance luminance of the mobile phone 10. Therefore, the CPU 17 is able to determine whether the surroundings of the mobile phone 10 are bright or not by determining with this detected data 52 whether a change of the light intensity has occurred over a predetermined value.

The memory portion 16 for example has a nonvolatile semiconductor memory, a hard disk drive, an optical disk drive, or other nonvolatile storage device and for example an SRAM, DRAM, or other random access storage device. The memory portion 16 stores different types of programs which are executed by the CPU 17 at the time of the various processing of the mobile phone 10. In addition, the memory portion 16 stores data used in the different types of processing.

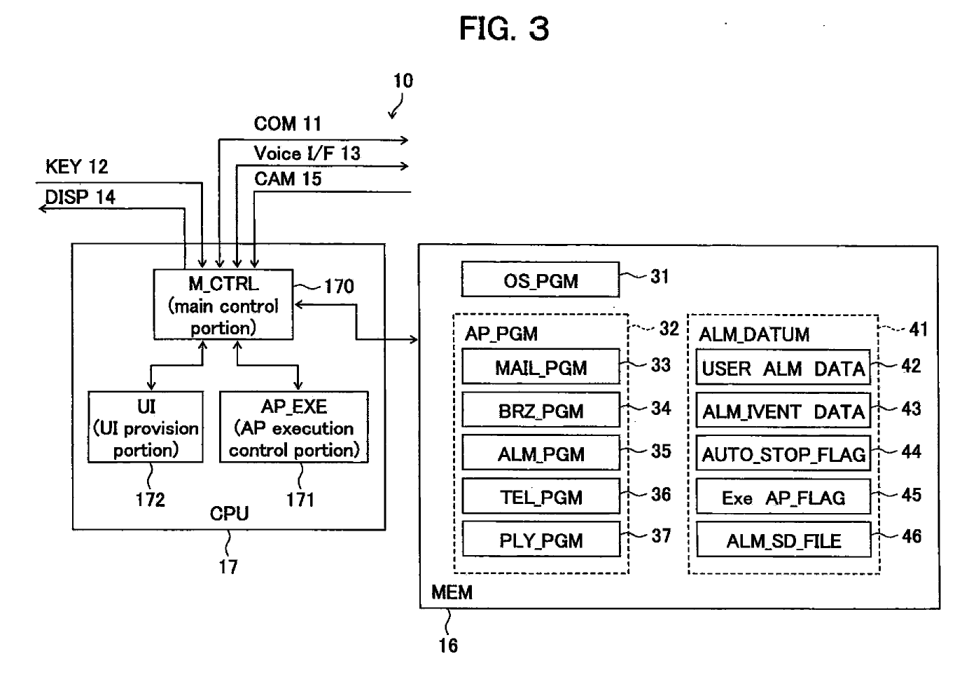

In FIG. 3 described below, the data stored in the memory portion 16 is shown. As shown in FIG. 3, the programs stored in the memory portion 16 include programs to be executed by the CPU 17 such as OS program (OS_PGM: operating system program) 31 and AP programs (AP_PGM: application programs) 32. The AP programs 32 include, for example, a mailer program (MAIL_PGM) 33, a web browser program (BRZ_PGM) 34, an alarm program (ALM_PGM) 35, a telephone program (TEL_PGM) 36, and a player program (PLY_PGM) 37.

The data stored in the memory portion 16 includes alarm data (ALM_DATUM) 41 used in alarm processing for example. The alarm data 41 includes alarm setting data (USER ALM DATA) 42, alarm event data (ALM EVENT DATA) 43, an alarm automatic stop flag (AUTO STOP FLAG) 44, an execution AP flag (Exe AP FLAG) 45, and an alarm sound data file (ALM_SD FILE) 46 including alarm sound data being played as an alarm. The alarm setting data 42 is data which includes information of a setting time of an alarm set by a user. The alarm event data 43 is event data generated based on the alarm setting data 42. The alarm automatic stop flag 44 is flag data which shows a valid or invalid state of alarm automatic stop processing. The execution AP flag 45 is flag data which shows AP programming 32 in execution.

The memory portion 16, in addition to the data shown in FIG. 3, for example stores address book data managing personal information such as phone numbers, e-mail addresses, and so on of other parties, sound playback data files of incoming call sounds, image files of image data displayed in a call standby state, different types of setting data, and temporary data used in the procedures of processing of programs.

Note that the different types of programs 31 to 37 and data stored in the memory portion 16 and able to be executed by the CPU 17 may be originally recorded in a computer readable recording medium and installed in the mobile phone 10 for example. In addition, the programs 31 to 37 and data may be downloaded from servers via a transmission medium such as the Internet and so on and installed in the mobile phone 10.

The CPU 17 includes a microprocessor or other computer which reads out and processes the programs in the memory portion 16 and functions as a processing portion of the mobile phone 10. The control portion 18 successively reads out and executes operation codes described in the OS program 31 and the AP programs 32 from the memory portion 16. Further, the CPU 17 controls the overall operations of the mobile phone 10. For example, the CPU 17 controls the operations of the circuits 11 to 16 in FIG. 2, so that the different types of processing of the mobile phone 10 are executed by suitable routines according to the operations of the operation portion 12. The different types of the processing of the mobile phone 10 include for example alarm processing; voice call processing performed via a line switching network; e-mail generating processing, sending processing, or receiving processing; web (World Wide Web) site browsing processing of the Internet; etc. In addition, the operations of the circuits 11 to 16 of the mobile phone 10 includes an output of an alarm sound by the voice input/output portion 13 and the speaker 19, signal sending or signal receiving of the communication portion 11, voice input/output of the voice input/output portion 13, image display of the display portion 14, and imaging of the imaging portion 15, for example.

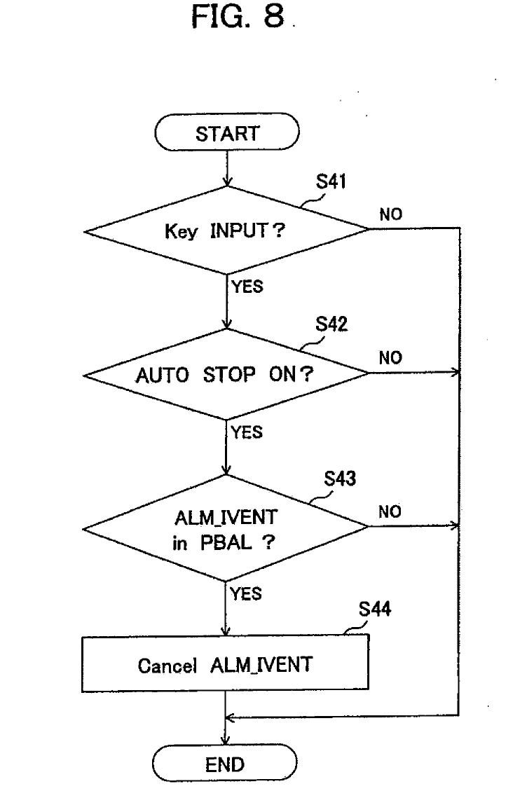

In addition, the CPU 17 determines, for example as shown in FIG. 8 to FIG. 11 described below, whether or not the alarm stop condition is satisfied in a pre-sound operation period PBAL from a predetermined time before an alarm setting time to the alarm setting time which is set by a user. The CPU 17 selects to execute one of the alarm event canceling processing in FIG. 8 to FIG. 11 based on alarm setting by a user. The pre-sound operation period PBAL is a period corresponding to each of the alarm events to determine whether or not the execution of the alarm event is to be prevented from emitting an alarm sound of the alarm event.

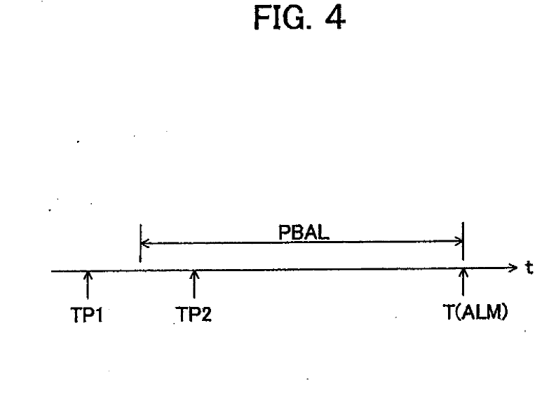

FIG. 4 shows a relationship between an alarm event setting time T(ALM) and a pre-sound operation period PBAL. The alarm event setting time T(ALM) in FIG. 4 is an alarm setting time which is set by a user, for example. Then, as shown in FIG. 4, the pre-sound operation period PBAL is set at a period from a predetermined time before the alarm setting time to the alarm setting time of each of the alarm events.

As shown in FIG. 8 to FIG. 11 described below, the CPU 17 determines, for example, whether or not the alarm stop condition is satisfied in the pre-sound operation period PBAL. For example, in a case where the present time is at a timing TP1 in FIG. 4, the alarm stop condition is not satisfied. Therefore, the CPU 17 determines that the alarm stop condition of the alarm event in FIG. 4 is not satisfied. In addition, in a case where the present time is at a timing TP2 in FIG. 4 and where the alarm stop condition is satisfied, the CPU 17 determines that alarm stop condition of the alarm event in FIG. 4 is satisfied.

When the alarm stop condition is satisfied in the pre-sound operation period PBAL, the CPU 17, for example, cancels output of an alarm sound at a scheduled alarm setting time. For example, in a case where an alarm is repeatedly set at the same time each day, the alarm output may be canceled each time the alarm stop condition is satisfied or the repeatedly set alarm outputs may all be halted. Alternatively, the CPU 17 prompts the user to select whether or not to cancel an output of an alarm sound at a scheduled alarm setting time.

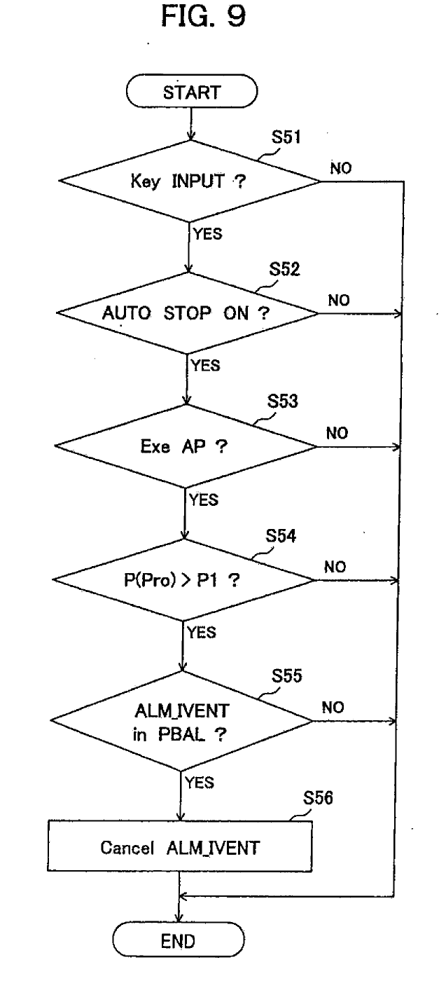

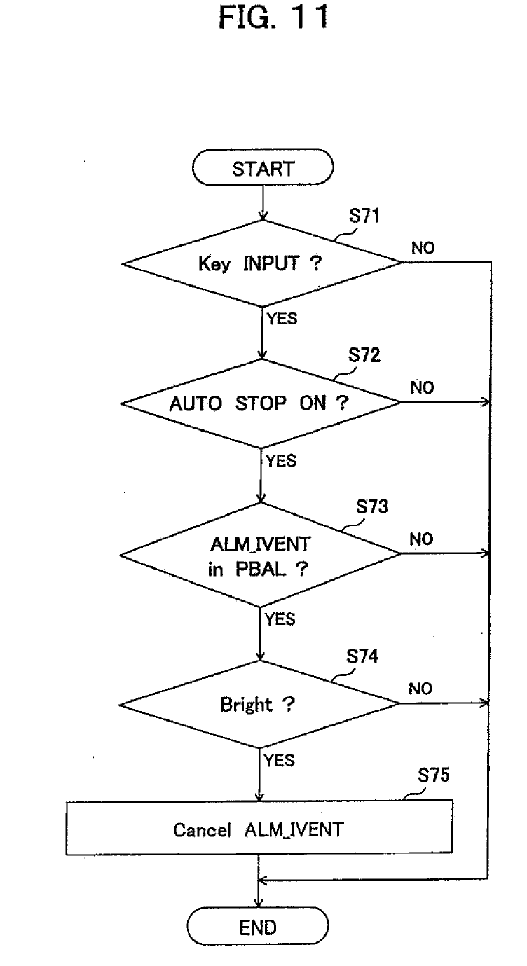

Specifically, the alarm stop condition is determined by the different types of determination processing in FIG. 8 to FIG. 11 described below. The alarm stop condition may be a condition at least to determine indirectly that a user has woken up. Note that, a situation where a user intentionally stops the alarm, such as a user starting up the alarm AP program 35 by the operation portion 12 and performing an alarm stop operation to stop in advance an alarm to be operated at an alarm time, is excluded from the alarm stop condition. For example, in FIG. 9, the alarm stop condition is a condition where the AP program 32 is started up by a user operation and where the mobile phone 10 is in an startup state. In addition, in FIG. 11, the alarm stop condition is a condition where a light receiving element 15a of the imaging portion 15 receives light over a predetermined value.

FIG. 3 shows a block diagram of functions realized in the CPU 17 of FIG. 2 in a case where the CPU 17 executes an OS program 31. As shown in FIG. 3, a main control portion (M_CTRL) 170, an AP execution control portion (AP_EXE: application program execution control portion) 171, and an UI provision portion (UI: user interface provision portion) 172 are realized in the CPU 17 by execution of the OS program 31.

The AP execution control portion 171 executes the AP programs 32 stored in the memory portion 16. In addition, the AP execution control portion 171 manages execution states of the AP programs 32. Then, the AP execution control portion 171 informs the main control portion 170 of a state of an alarm stop condition in which at least one of the AP programs 32 is started up based on a user operation as to be started up continuously over a predetermined time in the pre-sound operation period PBAL.

The UI provision portion 172 provides a user interface using the operation portion 12 and the display portion 14 in a case where a user operates the different types of settings. A user uses the user interface provided by the UI provision portion 172 to set the alarm setting time and a valid or invalid state of the alarm automatic stop setting described above, for example. In addition, a user further sets a value of the pre-sound operation period PBAL described above, the type of the AP program 32 used for the determination of a user waking up, an AP program 32 to determine a user waking up, a determination value of continuously startup time thereof, and a threshold value for the light intensity determination.

The main control portion 170 provides interfaces for peripheral circuits such as a communication portion 11, an operation portion 12, a voice input/output portion 13, a display portion 14, an imaging portion 15, a memory portion 16 and so on. The main control portion 170 performs a sequential control, which relates to data hand over processing between the AP execution control portion 171 and the UI provision portion 172, and so on.

In addition, the main control portion 170 executes the different types of processing for emitting an alarm sound at a user alarm setting time. In the first embodiment, the main control portion 170 executes alarm event setting processing for outputting an alarm sound at a user setting time, alarm event executing processing at the alarm setting time, and alarm event canceling processing before the alarm setting time. In addition, in the canceling processing, the main control portion 170 determines whether or not an alarm stop condition is satisfied in the pre-sound operation period PBAL from a predetermined time before the alarm setting time to the alarm setting time. When the alarm stop condition is satisfied in the pre-sound operation period PBAL, the main control portion 170 cancels output of the alarm sound at the alarm setting time, for example. Otherwise, the main control portion 170 makes a user select whether or not to cancel the output of the alarm sound in advance at the alarm setting time by using the user interface of the UI provision portion 172.

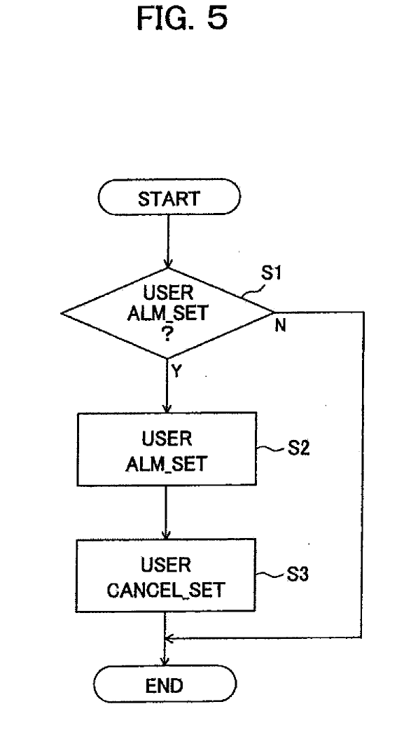

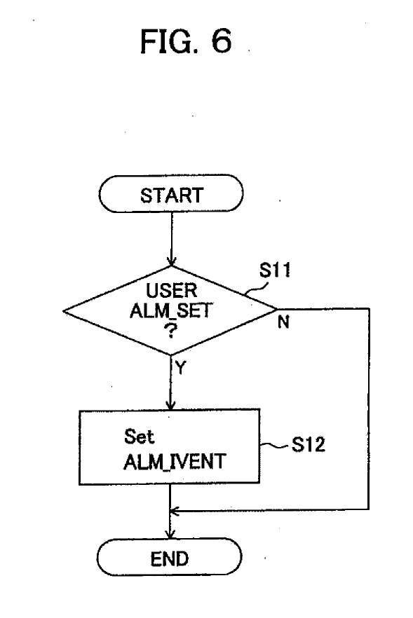

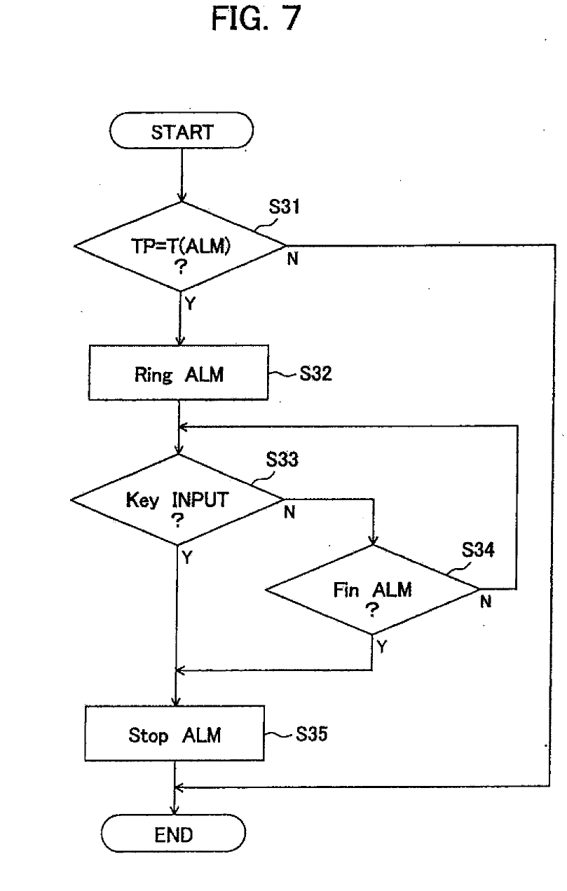

Next, control of the alarm function of the mobile phone 10 of the first embodiment having the above mentioned structure will be explained. In the following explanation, user alarm setting processing in FIG. 5, alarm event setting processing in FIG. 6, an alarm event executing processing in FIG. 7, and alarm event canceling processing in FIG. 8 to FIG. 11 will be explained in that order. The main control portion 170 selects to execute one of the alarm event canceling processing in FIG. 8 to FIG. 11 based on the user alarm setting.

(User Alarm Setting Processing)

When a user sets an alarm, the main control portion 170 makes the AP execution control portion 171 in FIG. 3 execute the alarm program 35. Due to this, the AP execution control portion 171 executes the user alarm setting processing in FIG. 5.

In the user alarm setting processing in FIG. 5, the AP execution control portion 171 judges existence of an alarm setting request by a user (step S1). The AP execution control portion 171 judges that there is an alarm setting request in a case where an item “alarm set” is selected from a menu of the mobile phone, for example. Further, in a case where there is no request by the user for setting the alarm, the AP execution control portion 171 ends the alarm setting processing in FIG. 5.

When there is a request by the user for setting the alarm, the AP execution control portion 171 executes alarm setting processing (step S2). The AP execution control portion 171 makes the display portion 14 display a screen to input an alarm setting time and so on. In addition, the AP execution control portion 171 acquires input data such as an alarm setting time and so on from the operation portion 12 and stores it in the memory portion 16. Due to this, the alarm setting data 42, pre-sound operation period PBAL, and so on set by the user are stored in the memory portion 16.

After making the memory portion 16 store the alarm setting data 42 and so on, the AP execution control portion 171 further executes the alarm automatic stop setting processing (step S3). The AP execution control portion 171 makes the display portion 14 display a screen to set an automatic stop condition of the alarm addition, the AP execution control portion 171 acquires input data which relates to the need of the alarm automatic stop setting from the operation portion 12 and stores it in the memory portion 16. As a result, the memory portion 16 stores an alarm automatic stop flag 44 which shows a valid or invalid state of the alarm automatic stop process.

(Alarm Event Setting Processing)

FIG. 6 shows a flow chart of alarm event setting processing executed by the main control portion 170 in FIG. 3. The main control portion 170 makes the AP execution control portion 171 execute the processing in FIG. 5 and then executes the processing in FIG. 6, for example.

in addition, the main control portion 170 periodically and repeatedly executes the processing in FIG. 6. By repeatedly executing the processing in FIG. 6, the main control portion 170 is able to set a plurality of alarm events from the alarm setting data 42. For example, in a case where the alarm setting data 42 is data to repeat alarms daily at a predetermined time, the main control portion 170 is able to set the alarm event at the predetermined time of each day from the alarm setting data 42.

In the alarm event setting processing in FIG. 6, the main control portion 170 judges the existence of an alarm setting (step S11). For example in a case where the memory portion 16 stores alarm setting data 42, the main control portion 170 judges that an alarm is set. Further, in a case where the alarm is not set, the main control portion 170 ends the alarm event setting processing in FIG. 6.

When the alarm is set, the main control portion 170 reads out the alarm setting data 42 from the memory portion 16 and generates an event to output an alarm sound at the setting time (step S12). The main control portion 170 stores the generated alarm event setting time in the memory portion 16. Due to this, the memory portion 16 stores alarm event data 43.

(Alarm Sound Output Processing)

FIG. 7 shows a flow chart of alarm event executing processing executed by the main control portion 170 in FIG. 3.

In the alarm event executing processing in FIG. 7, the main control portion 170 judges whether or not the present time TP reaches the setting time T(ALM) stored as the alarm event data 43 (step S31). The present time TP may be measured by a not-shown timer within the CPU 17, for example. Further, in a case where the present time TP does not reach the setting time T(ALM), the main control portion 170 ends the alarm event executing processing in FIG. 7.

When the present time TP reaches the setting time T(ALM), the main control portion 170 executes the output processing of the alarm sound (step S32). The main control portion 170 reads out the alarm sound data file 46 including alarm audio sound data from the memory portion 16 and outputs an alarm signal to the voice input/output portion 13. The voice input/output portion 13 generates a playback sound signal based on the audio sound data and outputs it to the speaker 19. Due to this the speaker 19 outputs the alarm sound.

After performing the output processing of the alarm sound, the main control portion 170 is in a waiting state for input stopping the alarm sound. The main control portion 170 judges existence of an input signal of a key operation from the operation portion 12 (step S33) and, when no signal is input, further judges whether or not the on-going alarm output is to be ended (step S34). The main control portion 170 repeatedly judges steps from S33 to S34 until a signal of a key operation is input from the operation portion 12 or until judging that the output of the alarm sound is to be ended.

Then, when the input signal of a key operation is judged as being input from the operation portion 12 at step S33, the main control portion 170 outputs a signal for instructing stopping of the alarm to the voice input/output portion 13 (step S35). The voice input/output portion 13 stops the output of the playback sound signal to the speaker 19. Due to this, the speaker 19 ends the output of the alarm sound.

In addition, when a predetermined alarm output period passes and it is determined to end the output of the alarm sound at step S34, for example, the main control portion 170 outputs a signal for stopping the alarm to the voice input/output portion 13 (step S35). Due to this, the speaker 19 stops outputting the alarm sound.

Next, the alarm event canceling processing in FIG. 8 to FIG. 11 will be explained. The main control portion 170 selects one of a plurality of alarm event canceling processing in FIG. 8 to FIG. 11 according to a user setting to execute canceling processing.

(First Example of Alarm Automatic Canceling Processing)

First, referring to the flow chart in FIG. 8, basic alarm automatic canceling processing of the main control portion 170 will be explained. In FIG. 8, the main control portion 170 cancels an alarm event automatically by depression of a key.

In the alarm automatic canceling processing in FIG. 8, when a key of the operation portion 12 is operated (step S41), the main control portion 170 then judges whether or not an alarm automatic stop setting is valid (step S42). The main control portion 170 judges the valid or invalid state of the alarm automatic stop setting by the value of the alarm automatic stop flag 44 in the memory portion 16, for example.

The information of the alarm automatic stop setting used for the judgment at step S42 is previously set at step S3 of FIG. 5. At step S3 of FIG. 5, the main control portion 170 makes the display portion 14 display a setting screen with the UI provision portion 172. The user operates the operation portion 12 and sets the valid or invalid state of the alarm automatic stop setting. The UI provision portion 172 reads out the input valid or invalid setting and passes it on to the main control portion 170. When acquiring a valid setting from the UI provision portion 172, the main control portion 170 sets the alarm automatic stop flag 44 to an ON (valid) value.

When judging that the alarm automatic stop setting is valid at step S42, the main control portion 170 further judges existence of any alarm event at which the present time TP is included in the pre-sound operation period PBAL (step S43). The main control portion 170 reads out the alarm event data 43 of the memory portion 16 and judges if there is any alarm event at which the present time TP is in the pre-sound operation period PBAL.

When it is judged that there is any alarm event in which the present time TP is in the pre-sound operation period PBAL at step S43, the main control portion 170 performs alarm stop processing and stops the corresponding alarm event (step S44). The main control portion 170 deletes or cancels an alarm event data 43 matching the alarm stop condition from the memory portion 16.

As described above, in the first example of the alarm automatic canceling processing of FIG. 8, the alarm automatic stop setting, the pre-sound operation period PBAL, and so on are previously set using the user interface. Based on the setting, the alarm event is automatically canceled before output of the alarm sound. Therefore, an alarm sound is never emitted due to such an alarm event. In addition, to stop the alarm from outputting the alarm sound in advance, a user does not have to select the alarm setting item from the menu of the mobile phone to delete the pre-emission alarm setting data 42. Therefore, the operations on the part of the user is reduced. In addition, in the first example of the alarm automatic canceling processing in FIG. 8, the mobile phone 10 finely controls the cancellation of the output of the alarm sound based on easy user setting. Therefore, the user-friendliness of the mobile phone 10 is increased.

(Second Example of Alarm Automatic Canceling Processing)

Next, while referring to the flow chart in FIG. 9, another example of the alarm automatic canceling processing of the main control portion 170 will be explained. In FIG. 9, the main control portion 170 uses an startup time of a specific AP program 32 for the judgment of the alarm stop condition.

In the alarm automatic canceling processing in FIG. 9, when a key of the operation portion 12 is operated (step S51), the main control portion 170 judges whether or not the alarm automatic stop setting is valid (step S52).

When the alarm automatic stop setting is judged as valid at step S52, the main control portion 170 further judges whether, or not a determination-use AP program is started up (step S53).

The “determination-use AP program” means an AP program 32 which is able to determine if a user is operating the mobile phone 10. The determination-use AP program may be the mailer program 33, the web browser program 34, the call program 36, the player program 37, and so on to be started up by a user operation, for example. Further, the AP execution control portion 171 sets a predetermined value for the execution AP flag 45 in a case where the determination-use AP program is executed over a predetermined period. Therefore, the main control portion 170, for example, confirms that the execution AP flag 45 is the predetermined value in the pre-sound operation period PBAL so as to judge if that the determination-use AP program is continuously started up for the predetermined period in the pre-sound operation period PBAL.

The determination-use AP program judged at step S53 is previously set at step S3 of FIG. 5. At step S3 of FIG. 5, the main control portion 170 makes the display portion 14 display a setting screen with the UI provision portion 172. A user operates the operation portion 12 to set the determination-use AP program. The UI provision portion 172 reads out an input setting of the determination-use AP program and passes it on to the main control portion 170. The main control portion 170 sets the determination-use AP program.

Further, at the second example, a determination time for judging the duration after startup of the determination-use AP program is previously set at step S3 of FIG. 5. The setting data such as the setting value of the determination-use AP program, the duration after startup, and so on are allocated to and stored at in a predetermined area of the memory portion 16.

Next, the main control portion 170 refers to the predetermined area of the memory portion 16. When judging that the execution AP flag 45 is in the on state, the main control portion 170 further judges whether or not the execution period P(Pro) of the determination-use AP program exceeds the judgment period P1 (step S54).

When it is determined that the execution period P(Pro) of the determination-use AP program exceeds the judgment period P1 at step S54, the main control portion 170 further judges existence of any alarm event at which the present time is included in the pre-sound operation period PBAL (step S55). In addition, even in a case where the execution period P(Pro) of the determination-use AP program does not exceed the judgment period, the main control portion 170 may further judge existence of any alarm event at which the present time is included in the pre-sound operation period PBAL when it is judged that the determination-use AP program is started up.

When the main control portion 170 judges at step S55 that an alarm event at which the present time TP is included in the pre-sound operation period PBAL is set, the main control portion 170 performs alarm stop processing to stop the corresponding alarm event (step S56). The main control portion 170 deletes or cancels the alarm event data 43 matching the alarm stop condition from the memory portion 16, for example.

As described above, in the second example of the alarm automatic canceling processing in FIG. 9, the startup time of the specified AP program 32 to be executed by a user operation is used for the determination of the alarm stop condition. Whether the user is operating the mobile phone 10 before the alarm sound is output is judged. Then, the alarm event is automatically canceled before the alarm sound is output based on the determination result. Therefore, the alarm sound of the alarm event will not be emitted. In addition, to stop the alarm before the alarm sound is output, a user does not have to select the alarm setting from the menu of the mobile phone to delete the alarm setting data 42 before output. Therefore, the operations to the user can be eliminated. In addition, in the second example of the alarm automatic canceling processing in FIG. 9, the mobile phone 10 controls the cancellation of the output of the alarm sound extremely finely based on an easy user settings. Therefore, the user-friendliness of the mobile phone 10 is improved.

(Third Example of Alarm Automatic Canceling Processing)

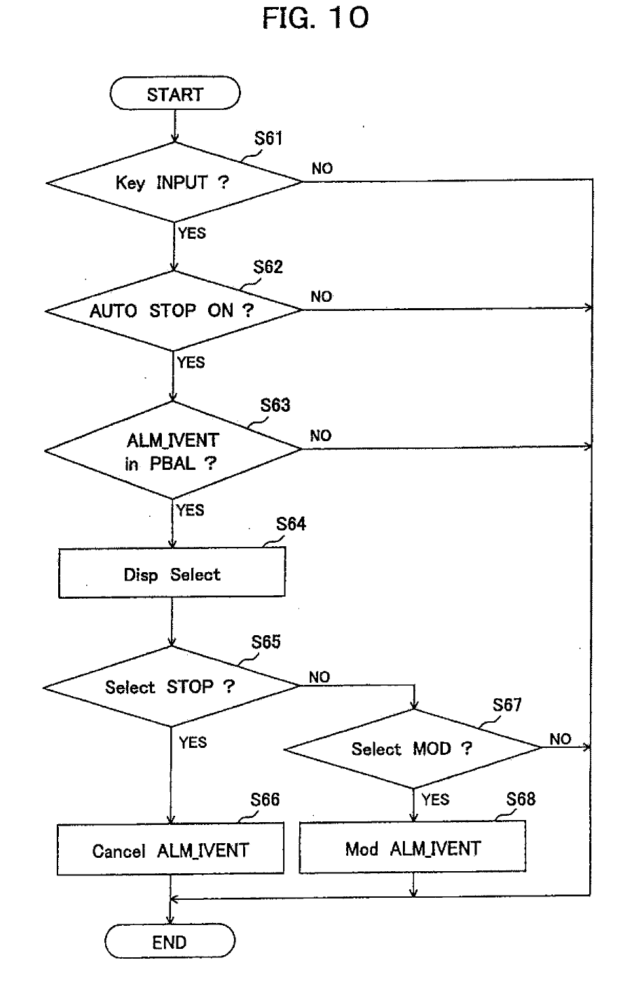

Next, with reference to the flow chart in FIG. 10, another example of the alarm automatic canceling processing of the main control portion 170 will be explained. In FIG. 10, the main control portion 170 automatically stops or changes an alarm event in accordance with a user selection.

In the alarm automatic canceling processing in FIG. 10, when judging that a key of the operation portion 12 is operated (step S61), the main control portion 170 judges whether or not the alarm automatic stop processing is validly set (step S62).

When the automatic stop processing is judged to be validly set at step S62, the main control portion 170 further judges existence of any alarm event at which the present time TP is included in the pre-sound operation period PBAL of the alarm event (step S63).

When it is judged that the alarm event at which the present time TP is within the pre-sound operation period PBAL is set at step S63, the main control portion 170 makes the display portion 14 display a user selecting screen with the UI provision portion 172 (step S64). The display portion 14 displays a message such as “Reserved alarm canceled?” and so on. Due to this, the mobile phone 10 prompts a user to input his or her intent by operation of the operation portion 12.

When a user operates the operation portion 12 to input “stop”, the main control portion 170 performs alarm stop processing and stops the corresponding alarm event (step S66). The main control portion 170 deletes or cancels the alarm event data 43 from the memory portion 16.

On the other hand, when it is judged at step S65 that the user has not input “stop”, the main control portion 170 further judges whether or not “change” is input (step S67). Then, when the user operates the operation portion 12 to input “change”, the main control portion 170 reads this through the UI provision portion 172 and performs change processing (step S68).

In the change processing of the step S68, the main control portion 170 makes the display portion 14 display an edit screen by the UI provision portion 172, for example. The edit screen displays for example “30 minutes later”, “60 minutes later”, and other such candidates for the time intervals to be changed to. The user operates the operation portion 12 to select one of the time intervals. The UI provision portion 172 provides information of the time interval selected by the user to the main control portion 170. The main control portion 170 uses the information of the time interval provided by the UI provision portion 172 to change the timing for execution of the alarm event at that time interval.

As described above, in the third example of the alarm automatic canceling processing in FIG. 10, the alarm event is canceled or changed based on a user key operation before the alarm sound is output. Therefore, the alarm sound is not emitted at the initially scheduled time. In addition, to stop the alarm before the alarm sound is output at the initially scheduled time, the user does not need to select the alarm setting item from the menu of the mobile phone and delete the pre-emission alarm setting data 42. Therefore, the operations to the user can be eliminated. In addition, in the third example of the alarm automatic canceling processing of FIG. 10, the mobile phone 10 displays the change screen corresponding to the key operation. Therefore, it is easy to change the output time of the alarm sound.

(Fourth Example of Alarm Automatic Canceling Processing)

Next, referring to the flow chart in FIG. 11, another example of the alarm automatic canceling processing of the main control portion 170 will be explained. In FIG. 11, the main control portion 170 uses room brightness for determination of the alarm stop condition.

In the alarm automatic canceling processing of FIG. 11, when a key of the operation portion 12 is operated (step S71), the main control portion 170 judges whether or not the alarm automatic stop processing is valid (step S72).

When it is judged that the alarm automatic stop processing is validly set at step S72, the main control portion 170 further judges whether or not an alarm event at which the present time is within the pre-sound operation period PBAL is set (step S73).

When an alarm event at which the present time TP is within the pre-sound operation period PBAL is set, the main control portion 170 starts up the imaging portion 15 and measures the brightness of the surroundings of the mobile phone 10 (step S74).

When the detected value of the brightness of the surroundings measured at step S74 is determined to be brighter in comparison with a predetermined threshold value, the main control portion 170 deems that the user has woken up and performs alarm stop processing to stop the corresponding alarm event (step S75). To measure the surrounding brightness of the mobile phone 10, it is also possible to perform measurement by only a photo sensor or optical sensor without starting up the imaging portion 15. The main control portion 170 deletes or cancels the alarm event data 43 from the memory portion 16.

As described above, in the fourth example of the alarm automatic canceling processing of FIG. 11, the room brightness is used for determination of the alarm stop condition to atop an alarm event. Therefore, the alarm sound is not emitted by an alarm event. In addition, to stop the alarm before the alarm is output, the user does not have to select the alarm setting item from the menu of the mobile phone and delete the pre-emission alarm setting data 42. Therefore, the operations to the user is eliminated. In addition, in the fourth example of the alarm automatic canceling processing of FIG. 11, the mobile phone 10 controls cancellation of alarm information finely based on an easy user operation. Therefore, the user-friendliness of the mobile phone 10 is improved.

(Modified Example of First Example of Alarm Automatic Canceling Processing)

As described above, the mobile phone 10 of the first embodiment executes four types of alarm automatic canceling processing in FIG. 8 to FIG. 11 to stop an alarm in accordance to a user setting. In addition, the mobile phone 10 of the first embodiment may stop an alarm when a user operates the operation portion 12 more than a predetermined number of times within a predetermined time.

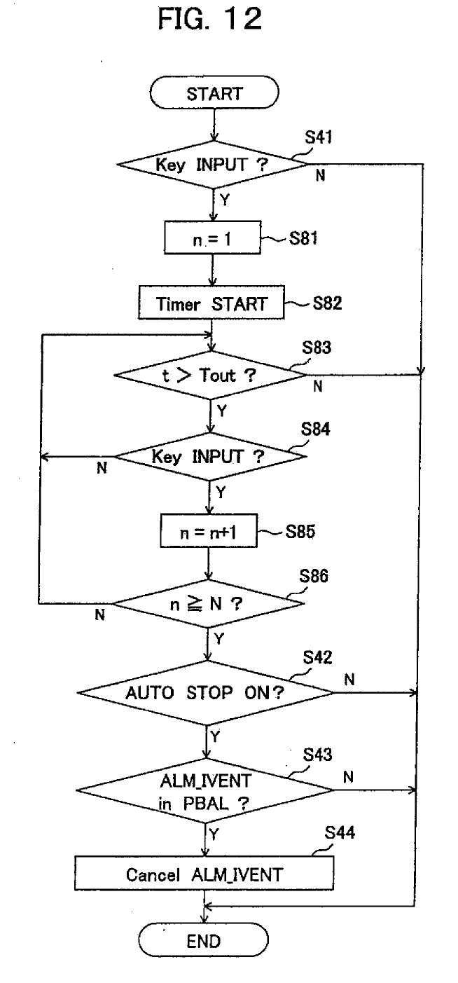

FIG. 12 is a flow chart showing a modified example of the first example of the alarm automatic canceling processing in FIG. 8.

In the alarm automatic canceling processing in FIG. 12, when a key of the operation portion 12 is operated (step S41), the main control portion 170 enters “1” for the loop variable “n” (“n” is a natural number of 1 or more) counting the number of times of key operation (step S81). In addition, the main control portion 170 starts a not shown internal timer (step S82).

Thereafter, the main control portion 170 enters a state waiting for the second and later key inputs. In the stating waiting for the second and later key inputs, the main control portion 170 judges whether or not a timeout time Tout has been exceeded (step S83) and further judges if there is any key operation (step S84). In addition, the main control portion 170 repeats the determination processing of steps S83 to S84 until a key is operated or until the timeout time Tout has elapsed. The timeout time Tout may be a time of about one minute in the pre-sound operation period PBAL, for example. In addition, the timeout time Tout may match with the pre-sound operation period PBAL.

When the timeout time Tout has elapsed, the main control portion 170 ends the alarm automatic canceling processing of FIG. 12. In this case, the main control portion 170 does not execute the alarm event stop processing at step S44.

When detecting a second or later key operation before the timeout time Tout has elapsed, the main control portion 170 adds “1” to the loop variable “n” (step S85) and judges whether or not the loop variable “n” has reached a predetermined number of times N (step S86). Then, when it is judged at step S86 that the loop variable “n” has not reached the predetermined number of times N, the main control portion 170 again enters at state waiting for the second or later key inputs. The main control portion 170 repeatedly executes steps S83 to S86.

When it is judged at step S86 that the loop variable “n” has reached the predetermined number of times N, the main control portion 170 judges whether or not an alarm automatic stop setting processing is validly set (step S42) and further judges whether or not an alarm event at which the present time TP is within the pre-sound operation period PBAL is set (step S43). Then, when it is judged at step S43 that an alarm event at which the present time TP within the pre-sound operation period PBAL is set, the main control portion 170 performs alarm stop processing and stops the corresponding alarm event (step S44). The main control portion 170 deletes or cancels the alarm event data 43 matching the alarm stop condition from the memory portion 16, for example.

As described above, in the modified example of the first example of the alarm automatic canceling processing of FIG. 12, the alarm event data 43 is deleted when operations are performed for a number of times equal to or more than the predetermined number of times N in the predetermined time Tout. Therefore, the operations to the user can be eliminated.

### Second Embodiment

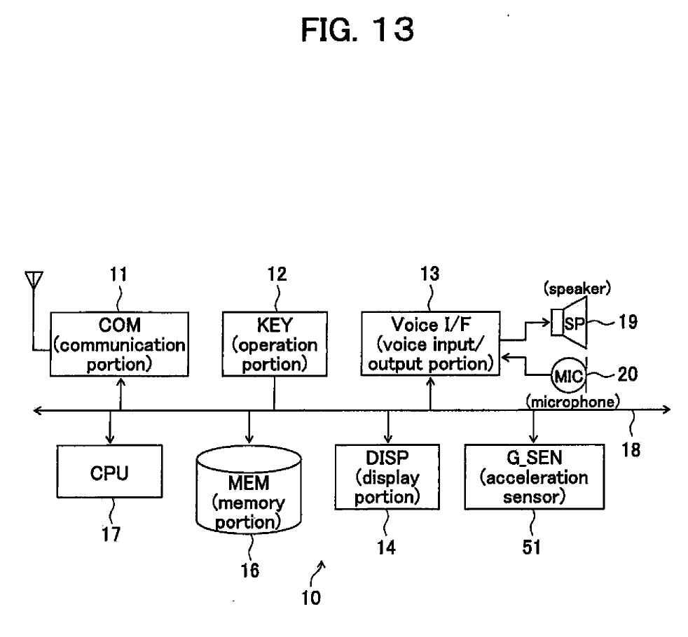

FIG. 13 is a block diagram showing main electric circuits of a mobile phone 10 of a second embodiment of the present invention. As shown in FIG. 13, the mobile phone 10 has an acceleration sensor (G_SEN) 51 connected to the system bus 18. The acceleration sensor 51 detects acceleration acting on the mobile phone 10 and outputs a detection signal to the CPU 17. The rest of the hardware configuration of the mobile phone 10 other than the acceleration sensor 51 is the same as the mobile phone 10 in the first embodiment, so the same reference numerals are attached and explanations are omitted.

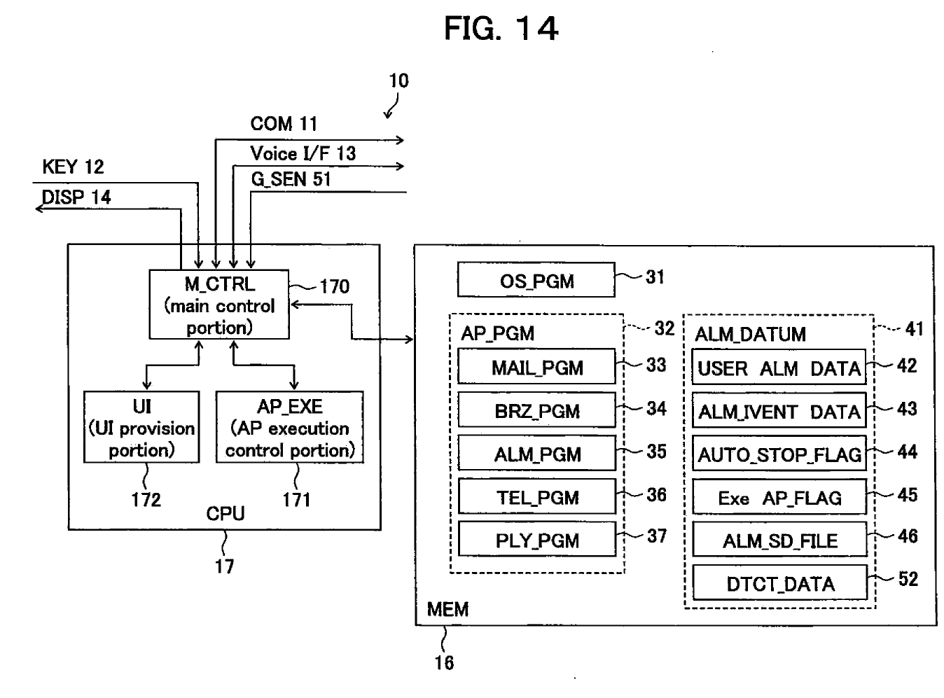

FIG. 14 is a view explaining recorded data stored in the memory portion 16 in FIG. 13. The memory portion 16 stores the detected data (DTCT DATA) 52. The detected data 52 include the value of acceleration detected by the acceleration sensor 51.

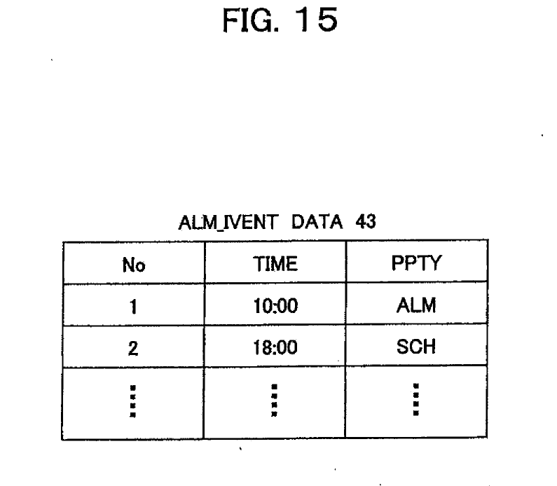

FIG. 15 is a view for explaining the data structure of the alarm event data 43 of the second embodiment in FIG. 14. The alarm event data 43 in FIG. 15 includes alarm setting time (TIME) information and alarm attribute information (PPTY) for each alarm event. The alarm events of the mobile phone 10 include, for example, a wakeup alarm event based on a user alarm setting and an alarm event based on a schedule setting. In the alarm event data 43 of FIG. 15, the first-line alarm event is an alarm event having a wakeup attribute based on an alarm (ALM) setting. The second-line alarm event is an alarm event based on a schedule setting. The attribute information of the alarms are set together with the alarm setting times when the main control portion 170 registers the alarm events in the alarm event data 43 based on the alarm setting data 42 in the alarm event setting processing in FIG. 6, for example.

Next, control of alarm functions of the mobile phone 10 of the second embodiment having the above-mentioned structure will be explained. The mobile phone 10 of the second embodiment, in the same way as the mobile phone 10 of the first embodiment, executes the user alarm setting processing in FIG. 5 and the alarm event setting processing in FIG. 6.

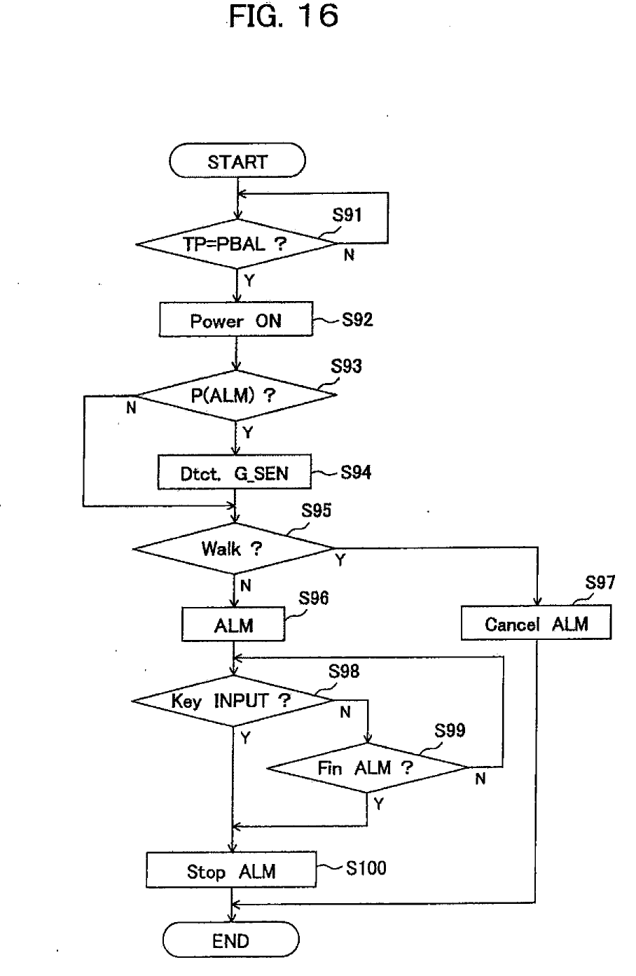

FIG. 16 is a flow chart showing an alarm event executing processing and an alarm automatic canceling processing of the mobile phone 10 in FIG. 13.

In the alarm automatic canceling processing in FIG. 16, the main control portion 170 of the CPU 17 determines whether the time is the pre-sound operation period PBAL or not (step S91). Then, when the time reaches the pre-sound operation period PBAL, the main control portion 170 begins the alarm event executing processing and the alarm automatic canceling processing.

First, the main control portion 170 controls the mobile phone 10 to power it up (step S92). Due to this, the peripheral circuits of the mobile phone 10 operate.

After the mobile phone 10 is started up, the main control portion 170 reads attribute information of the closest alarm event from the alarm event data 43 of the memory portion 16. Then, the main control portion 170 judges whether or not the readout attribute information of the alarm event indicates an alarm with a wakeup attribute (step S93).

When the readout attribute information of the alarm event indicates an alarm with a wakeup attribute, the main control portion 170 detects if the user is walking (step S94). In the detection of walking, the main control portion 170 reads detected data 52 of the acceleration sensor 51 for example.

After detecting existence of movement of the mobile phone 10 at steps S93 and S94, the main control portion 170 judges whether or not walking is detected (step S95). The main control portion 170 judges that the walking is detected in a case where an acceleration value indicated by the detected data 52 exceeds a predetermined value, for example. Note that, unlike the processing in FIG. 16, the main control portion 170 may control the mobile phone 10 to power it up at step S92, then read the detected data 52 of the acceleration sensor 51 at step S94 without regard as to the attribute information of the alarm event and detect walking at step S52.

When not detecting walking, the main control portion 170 executes output processing of an alarm sound (step S96). The main control portion 170 reads out the audio sound data file 46 of the alarm sound from the memory portion 16 and outputs a signal including the audio sound data to the voice input/output portion 13. The voice input/output portion 13 generates a playback sound signal from the audio sound data and outputs it to the speaker 19. Due to this, an alarm sound is output from the speaker 19.

After the output processing of the alarm sound, the main control portion 170 enters a waiting state for input to stop the alarm sound. The main control portion 170 judges whether or not an input signal of a key operation is input from the operation portion 12 (step S98). In a case of no input, the main control portion 170 further judges whether or not to end the output of the alarm sound (step S99). The main control portion 170 repeats the judgment from step S98 to S99 until an input signal of a key operation is input from the operation portion 12 or judging to end the output of the alarm sound.

When it is judged at step S98 that an input signal of a key operation is input from the operation portion 12, the main control portion 170 outputs a signal instructing to stop the alarm to the voice input/output portion 13 (step S100). The voice input/output portion 13 stops the output of the playback sound signal to the speaker 19. Due to this, the speaker 19 ends the output of the alarm sound.

In addition, when for example the predetermined period for emitting an alarm sound ends and the main control portion 170 determines to end the output of the alarm sound at step S99, the main control portion 170 outputs a signal instructing the stopping of the alarm to the voice input/output portion 13 (step S100). The voice input/output portion 13 stops the output of the playback sound signal to the speaker 19. Due to this, the output of the alarm sound from the speaker 19 ends.

On the other hand, when judging that walking is detected at step S95, the main control portion 170 makes the display portion 14 display a screen to inform the user that the output of the alarm sound has been canceled (step S97). In addition, the main control portion 170 ends the alarm event executing processing of FIG. 16 without executing the output processing of the alarm sound of step S96.

As described above, in the second embodiment, when detecting walking before the alarm sound is emitted, the output of the alarm sound for an alarm of the wakeup attribute is stopped. Therefore, when the user has woken up and is walking, the mobile phone 10 can stop the output of the alarm sound for an alarm of the wakeup attribute.

### Third Embodiment

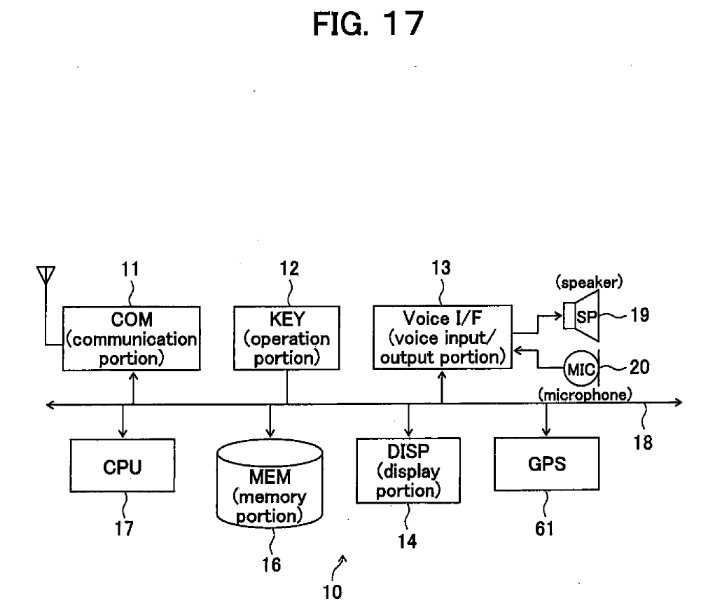

FIG. 17 is a block diagram showing main electric circuits of a mobile phone 10 of a third embodiment of the present invention. As shown in FIG. 17, the mobile phone 10 has a GPS (global positioning system) receiver 61 connected to the system bus 18. The rest of the hardware configuration of the mobile phone 10 other than the GPS receiver 61 is the same as the mobile phone 10 of the second embodiment, so the same reference numerals are assigned and explanations are omitted.

The GPS receiver 61 receives radio waves output from GPS satellites and calculates the position of the GPS receiver 61. In addition, the GPS receiver 61 outputs a signal including the calculated positional information to the CPU 17. The CPU 17 outputs the input positional information to the memory portion 16. The memory portion 16 stores the positional information as the detected data 52.

Next, the control of the alarm functions of the mobile phone 10 of the third embodiment having the above-mentioned configuration will be explained. The mobile phone 10 of the third embodiment, in the same way as the mobile phone 10 of the second embodiment, executes the user alarm setting processing in FIG. 5 and the alarm event setting processing in FIG. 6. In addition, in the alarm event setting processing in FIG. 6, the main control portion 170 executes the alarm event executing processing and the alarm automatic canceling processing in the pre-sound operation period PBAL. In addition, the main control portion 170 periodically acquires positional information of the GPS receiver 61 when an alarm is set.

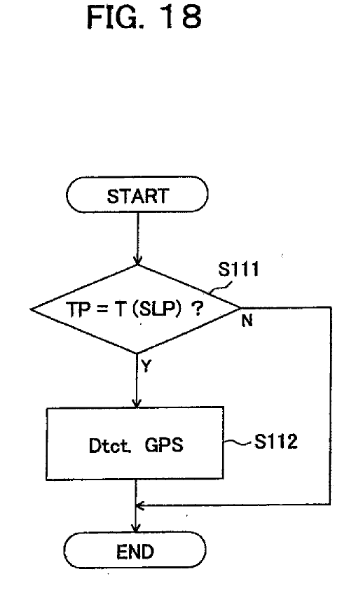

FIG. 18 is a flow chart showing processing for periodically acquiring positional information of the main control portion 170. In the positional information acquiring processing of FIG. 18, the main control portion 170 determines whether or not the present time TP is in a sleeping setting time T(SLP) (step S111). In the third embodiment, the sleeping setting time T(SLP) is set at step S2 of FIG. 5 together with the alarm setting time T(ALM) and so on, for example.

When the present time TP is the sleeping setting time T(SLP), the main control portion 170 acquires positional information of the GPS receiver 61 and stores it in the memory portion 16 (step S112). Due to this, the memory portion 16 stores the detected data 52 of the positional information.

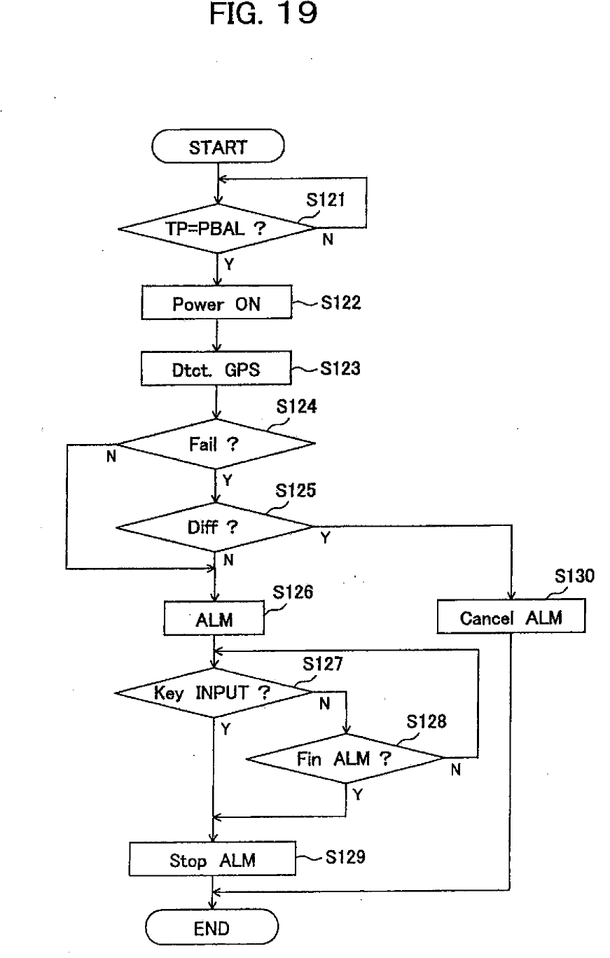

FIG. 19 is a flow chart showing the alarm event executing processing and the alarm automatic canceling processing of the mobile phone 10 in FIG. 17.

In the alarm automatic canceling processing of FIG. 19, the main control portion 170 of the CPU 17 determines whether the time is the pre-sound operation period PBAL or not (step S121). Then, when the pre-sound operation period PBAL, the main control portion 170 begins the alarm event executing processing and the alarm automatic canceling processing.

First, the main control portion 170 controls the mobile phone 10 to power it up (step S122). Due to this, the peripheral circuits of the mobile phone 10 operate.

After starting up the mobile phone 10, the main control portion 170 acquires the present positional information from the started up GPS receiver 61 (step S123).

After the present positional information acquiring processing, the main control portion 170 determines whether or not acquisition of either the sleeping positional information or the present positional information has failed (step S124).

When the acquisition of the positional information has not failed, these positional information are compared (step S125).

Then, when the position of the sleeping positional information and the position of the present positional information match, the main control portion 170 executes processing to output the alarm sound (step S126). Specifically, the main control portion 170 reads out the audio sound data file 46 of the alarm sound from the memory portion 16 and outputs a signal including the audio sound data to the voice input/output portion 13. The voice input/output portion 13 generates a playback sound signal from the audio sound data and outputs it to the speaker 19. Due to this, the speaker 19 outputs the alarm sound.

In addition, when acquisition of either the sleeping positional information or the present positional information has failed, the main control portion 170 executes processing for outputting the alarm sound (step S126).

After the processing for outputting the alarm sound, the main control portion 170 enters a state waiting for input to stop the alarm sound. The main control portion 170 judges whether or not an input signal of a key operation from the operation portion 12 is input (step S127) and, in a case where the signal is not input, further judges whether or not to end the output of the alarm sound (step S128). The main control portion 170 repeats the judgment from step S127 to S128 until the input signal of a key operation is input from the operation portion 12 or until it is judged to end the output of the alarm sound.

When it is judged at step S127 that the input signal of a key operation is input from the operation portion 12, the main control portion 170 outputs a signal instructing stopping of the alarm to the voice input/output portion 13 (step S129). The voice input/output portion 13 stops the output of the playback sound signal to the speaker 19. Due to this, the output of the alarm sound from the speaker 19 is ended.

In addition, when the predetermined period for emitting the alarm sound ends and it is judged at step S128 to end the output of the alarm sound, the main control portion 170 outputs a signal instructing stopping of the alarm to the voice input/output portion 13. The voice input/output portion 13 stops the output of the playback sound signal to the speaker 19. Due to this, the output of the alarm sound from the speaker 19 is ended.

On the other hand, when the position indicated by the positional information during sleeping and the position indicated by the present positional information do not match in the position determination of step S125, the main control portion 170 makes the display portion 14 display a screen informing the user of cancellation of the output of the alarm sound (step S130). In addition, the main control portion 170 ends the processing in FIG. 19 without executing the processing for outputting the alarm sound at step S126.

As described above, in the third embodiment, the output of an alarm sound is stopped when detecting a change of the positional information before the alarm sound is output. Therefore, when the user wakes up and moves from the sleeping area, the mobile phone 10 can stop the output of the alarm sound. The user-friendliness is therefore improved.

### Modified Example of Third Embodiment

The main control portion 170 of the third embodiment acquires the sleeping positional information in the processing of FIG. 18 based on the setting of the sleeping setting time T(SLP). In addition, the main control portion 170 may acquire the positional information whenever a predetermined time interval Tint elapses from the user setting the alarm.

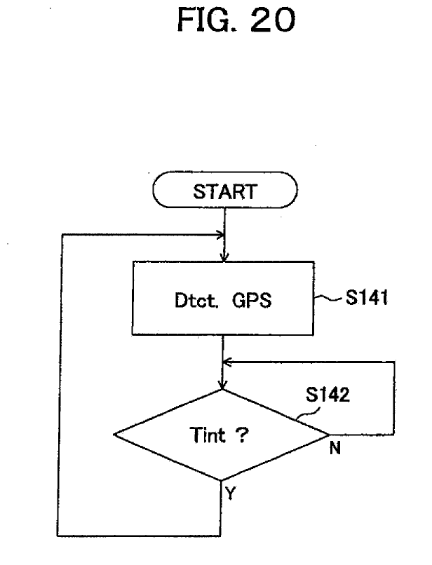

FIG. 20 is a flow chart showing processing for acquisition of positional information of the main control portion 170 of a modified example of the third embodiment.

In the processing for acquisition of the positional information of FIG. 20, first, the main control portion 170 acquires the positional information from the GPS receiver 61 and stores it in the memory portion 16 (step S141). Due to this, the detected data 52 of the positional information is stored in the memory portion 16.

After acquiring the positional information, the main control portion 170 judges whether or not a predetermined time interval Tint has elapsed (step S142).

Then, when a predetermined time interval Tint has elapsed, the main control portion 170 again acquires positional information from the GPS receiver 61 and stores it in the memory portion 16 (step S141). Due to this, the main control portion 170 acquires positional information at each predetermined time interval Tint, and the memory portion 16 stores the plurality of positional information of the predetermined time intervals Tint.

In addition, when the time reaches an alarm event executing time T(IVT), the main control portion 170 executes the processing of FIG. 19. In this modified example, before the main control portion 170 executes the alarm event executing processing, the memory portion 16 sometimes stores a plurality of positional information. In this case, if at least one of the positional information is not stored in the memory portion 16 at step S124 of FIG. 19, the main control portion 170 determines that the acquisition of sleeping positional information has failed. In addition, the main control portion 170 selects one of the plurality of positional information stored by the memory portion 16 at step S125 of FIG. 19 and compares the selected sleeping positional information with the present positional information. The main control portion 170 may select the positional information of the latest time from the plurality of positional information stored in the memory portion 16 for example.

The embodiments described above are preferable embodiments of the present invention. However, the present invention is not limited to them and may be modified or changed in various ways within the gist of the present invention.

For example, the above described embodiments are example of application of the electronic device of the present invention to one type of portable terminal, that is, a mobile phone 10. In addition, however, the electronic device of the present invention may be applied to a PDA (personal digital assistant), a mobile game device, and so on.

In the mobile phone 10 of the embodiments, the CPU 17 realizes the main control portion 170, the AP execution control portion 171, and the UI provision portion 172. In addition, the CPU 17 is used to execute the processing for a user to set the alarm, the processing for setting an alarm event based on a user setting, the alarm processing, the processing for cancellation of the alarm output, and other processing for outputting and canceling alarm sounds. In addition, part or all of the processing for outputting and canceling the alarm sound in the mobile phone 10 may be realized by hardware.

In the mobile phone 10 of the embodiments, the mobile phone 10 generates the alarm sound signal by the voice input/output portion 13 and outputs the alarm sound from the speaker 19. In addition, the mobile phone 10 may display an alarm screen by the display portion 14, and the main control portion 170 may perform the alarm operation at the alarm time by the display portion 14. In addition, the mobile phone 10 may have a vibrator which generates vibration for the alarm operation, and the main control portion 170 may perform the alarm operation at the alarm time by the vibrator.

In the first embodiment shown in FIG. 8 to FIG. 11, the alarm event canceling processing is executed based on a key operation of the operation portion 12. In addition, the main control portion 170 may detect the opening or closing of the upper housing 101 and the lower housing 102 of the mobile phone 10 and may execute the alarm event canceling processing in response to detection of the opening or closing. In addition, the main control portion 170 may determine the existence of an alarm event at which the present time TP is within the pre-sound operation period PBAL thereof and may execute the alarm event canceling processing in response to the determination result. As described above, when the main control portion 170 executes the canceling processing only by determination based on the time, the main control portion 170 can cancel the output of the alarm sound without requiring a user key operation. Therefore, for example in the case of FIG. 11, the user is able to cancel the output of the alarm sound by just moving the electronic device to a bright place.

In the second embodiment, the acceleration sensor 51 is added to the mobile phone 10, and predetermined motion of the mobile phone 10 by a user is detected based on the detection of this acceleration sensor 51 over the predetermined value. In addition, a geomagnetic sensor can be added to the mobile phone 10, and predetermined motion of the mobile phone 10 by a user may be detected based on a change of the detected direction of the geomagnetic sensor. In addition, an inclination sensor can be added to the mobile phone 10, and predetermined motion of the mobile phone 10 by a user may be detected based on a change of the inclination detection value of this inclination sensor. In addition, a contact sensor can be added to the mobile phone 10, and predetermined motion of the mobile phone 10 by a user may be detected based on a change of the contact state between this contact sensor and another portion. In addition, the main control portion 170 may determine that there has been predetermined motion of the mobile phone 10 when a predetermined detection state continues for at least a predetermined time rather than from single detection values of these sensors.

1. An electronic device comprising:
an alarm;
an alarm execution portion making the alarm execute an alarm operation at a previously set alarm time; and
a determination portion determining whether or not an alarm stop condition for stopping in advance the alarm operation by the alarm execution portion in a first period from a predetermined time before the alarm time to the alarm time is satisfied, wherein
the alarm execution portion does not operate the alarm at the alarm time in a case where the determination portion determines that the alarm stop condition is satisfied.

2. An electronic device as set forth in claim 1, wherein
the electronic device further has an operation portion, and
the alarm execution portion does not operate the alarm at the alarm time in a case where the determination portion determines that the alarm stop condition is satisfied and where the operation portion is operated.

3. An electronic device as set forth in claim 1, wherein
the electronic device further has a program executing portion executing a program, and
the determination portion determines that the alarm stop condition is satisfied in a case where the program executing portion is executing the program.

4. An electronic device as set forth in claim 1, wherein
the electronic device further has a light receiving portion, and
the determination portion determines that the alarm stop condition is satisfied in a case where the light receiving portion receives light over a predetermined value.

5. An electronic device as set forth in claim 1, wherein
the electronic device further has an operation portions, and
the determination portion determines that the alarm stop condition is satisfied in a case where the number of times of operation of the operation portion is a predetermined number or more.

6. An electronic device as set forth in claim 1, wherein
the electronic device further has a control portion, and
the control portion sets a power source in an on state when an off state of the power source is detected in the first period.

7. An electronic device as set forth in claim 1, wherein
the electronic device further has a detection portion detecting movement of the electronic device, and
the determination portion determines that the alarm stop condition is satisfied in a case where the detection portion detects movement of the electronic device.

8. An electronic device as set forth in claim 7, wherein the detection portion of the electronic device has an acceleration sensor, detects movement of the electronic device based on a detected acceleration of the acceleration sensor, and detects the predetermined movement of the electronic device in a case where the detected acceleration is a predetermined value or more.

9. An electronic device as set forth in claim 1, wherein
the electronic device further has a positional information acquiring portion acquiring positional information of the electronic device and a positional information memory portion storing the positional information which is previously acquired by the positional information acquiring portion, and
the determination portion determines that the alarm stop condition is satisfied in a case where the positional information previously acquired and stored in the positional information memory portion and the positional information which is acquired by the positional information acquiring portion are different from each other.

10. An electronic device as set forth in claim 9, wherein the positional information acquiring portion of the electronic device receives signals from GPS satellites and acquires the positional information based on the received signals.

11. An electronic device as set forth in claim 1, wherein
the electronic device further has:
an alarm event setting portion setting an alarm event designating the alarm time;
an alarm event storing portion storing the alarm event; and
an alarm event cancellation control portion deleting the alarm event from the alarm event storing portion in a case where the alarm stop condition is determined to be satisfied, and
the alarm execution portion makes the alarm execute an alarm operation at a designated time based on the alarm event.

12. An alarm control method of an electronic device performing an alarm operation comprising:
a determination step for determining whether or not an alarm stop condition for stopping in advance the alarm operation at an alarm time is satisfied in a first period from a predetermined time before the alarm time to the alarm time and
a step for preventing an alarm operation from being executed at the alarm time in a case where the alarm stop condition is determined to be satisfied in the determination step.

13. A computer readable recording medium recording a computer readable program for a computer of an electronic device connected to an alarm for an alarm operation,
making said computer execute
a determination step for determining whether or not an alarm stop condition for stopping in advance the alarm operation at an alarm time is satisfied in a first period from a predetermined time before the alarm time to the alarm time and
a step for preventing the alarm operation from being executed at the alarm time in a case where the alarm stop condition is determined to be satisfied in the determination step.
